(19) United States
(12) Patent Application Publication
(10) Pub. No.: US 2008/0046144 A1
(43) Pub. Date: Feb. 21, 2008

(54) System and method for measuring relative wheel velocity

(76) Inventor: Jerold L. Barlage, Russia, OH (US)

Correspondence Address: Delphi Technologies, Inc.;Legal Staff, M/C 480-410-202, P.O. Box 5052, Troy, MI, 48007-5052, US

(21) Appl. No.: 11/492,718

(22) Filed: Jul. 25, 2006

(51) Int. Cl. B60G 17/018

(52) U.S. Cl. 701/37

(57) ABSTRACT

A system for measuring relative wheel velocity including an unsprung mass having a wheel connected thereto, a sprung mass pivotally connected to the unsprung mass by a pivot point and an angular rate sensor mounted on the sprung mass (or the unsprung mass) generally adjacent to the pivot point.

### BACKGROUND

The present application relates to systems and methods for measuring relative wheel velocity and, more particularly, to systems and methods for measuring relative wheel velocity with an angular rate sensor.

Modern vehicles typically include one or more systems adapted to minimize the transfer of forces (e.g., road inputs) to the vehicle body. For example, vehicles may be provided with suspension systems, vehicle stability enhancement systems, roll control systems and the like for controlling vehicle dynamics in response to various inputs. Vehicle suspension systems typically include one or more dampers positioned between the wheel and the vehicle body for minimizing the forces transferred to the vehicle body.

Suspension systems and the like typically include a controller adapted to receive one or more input signals and generate a command signal based upon a difference between the input signal and a predetermined control signal (i.e., an error signal). The command signal may be communicated to the active component(s) of the system (e.g., a controllable magnetorheological fluid damper) for controlling the operation of the active component and minimizing the error signal.

Such systems typically require an input signal indicative of the relative wheel velocity (i.e., the velocity of the wheel relative to the body of the vehicle). As shown in FIG. 1, relative wheel velocity has traditionally been measured with a position sensor 10 positioned on the unsprung mass 12 of the vehicle (not shown) and connected to the sprung mass 14 by arms or links 16, 18. The signals generated in response to movement of the sprung mass 14 relative to the unsprung mass 12 may be differentiated into velocity signals and may be communicated to a controller (not shown) by a communication line 20.

The use of position sensors to measure relative wheel velocity has presented several disadvantages. For example, the need to differentiate the position signal to obtain a velocity signal greatly amplifies noise, resulting in a high signal to noise ratio that limits the frequency range at which the position sensor may operate. Furthermore, differentiating the position signal to a velocity signal creates a time delay that results in slower and less robust control. Still furthermore, position sensors typically are located at each corner of the vehicle. However, due to the unique spatial limitations at each corner of the vehicle, each corner typically requires a customized arrangement of mounting brackets, arms and/or links to properly connect the position sensor, thereby increasing manufacturing and assembly costs.

Accordingly, there is a need for a system and method for measuring relative wheel velocity without some or all of the disadvantages described above.

### SUMMARY

In one aspect, a system for measuring relative wheel velocity is provided and includes an unsprung mass having a wheel connected thereto, a sprung mass pivotally connected to the unsprung mass by a pivot point and an angular rate sensor mounted on the sprung mass (or the unsprung mass) generally adjacent to the pivot point.

In another aspect, a method for measuring relative wheel velocity is provided and includes the steps of providing a vehicle having a sprung mass pivotally connected to an unsprung mass by a pivot point, mounting an angular rate sensor on the sprung mass (or the unsprung mass) such that the angular rate sensor is positioned generally adjacent to the pivot point, and monitoring a signal generated by the angular rate sensor when the sprung mass pivots relative to the unsprung mass.

Other aspects of the disclosed system and method for measuring relative wheel velocity will become apparent from the following description, the accompanying drawings and the appended claims.

### BRIEF DESCRIPTION OF THE DRAWINGS

FIG. 1 is a perspective view of a prior art vehicle assembly including a position sensor mounted between the sprung mass and the unsprung mass; and

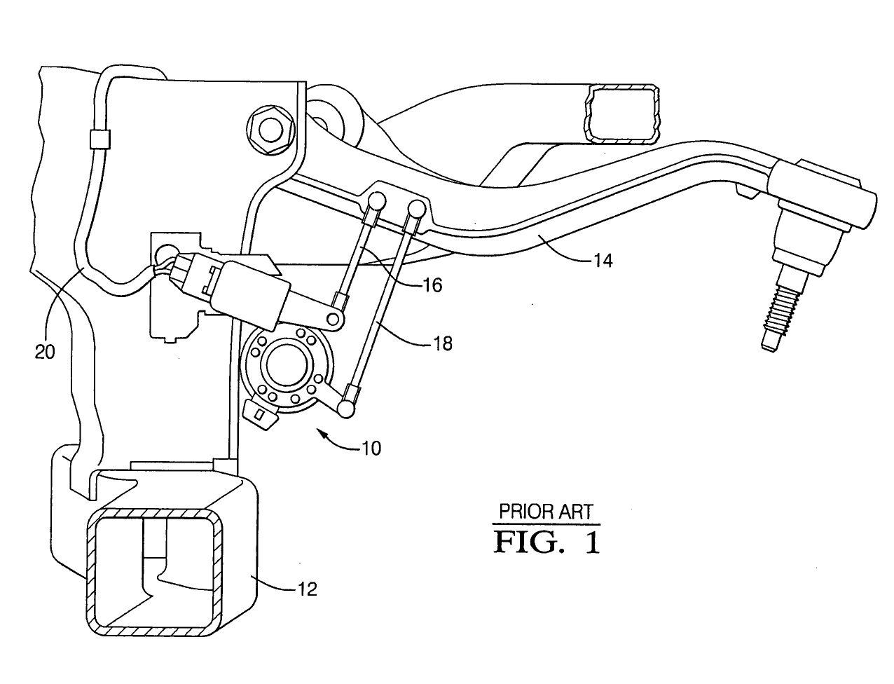

FIG. 2 is a perspective view of a vehicle assembly including an angular rate sensor mounted according to an aspect of the disclosed system and method for measuring relative wheel velocity.

### DETAILED DESCRIPTION

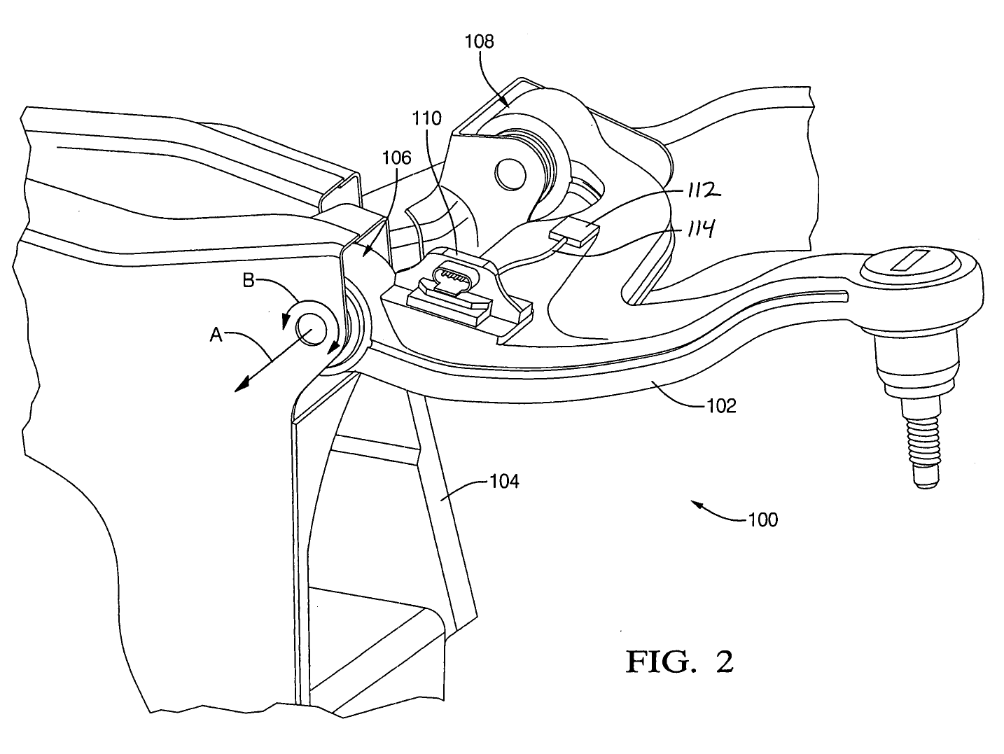

As shown in FIG. 2, each corner of a vehicle, generally designated 100, may include a sprung mass 102 connected to an unsprung mass 104 about a pivot axis A at pivot points 106, 108, thereby allowing the sprung mass to rotate relative to the unsprung mass in the direction shown by arrow B. A wheel (not shown) may be connected to the unsprung mass at each corner 100 of the vehicle.

In one aspect, as shown in FIG. 2, an angular rate sensor 110 may be mounted on the sprung mass 102 to measure the angular velocity or rotational speed of the sprung mass 102 relative to the unsprung mass 104 at each corner 100 of the vehicle. In another aspect, the angular rate sensor 110 may be mounted on the unsprung mass 104. In another aspect, each of the sprung mass 102 and unsprung mass 104 may include an angular rate sensor 110 mounted thereto.

The angular rate sensor 110 may be mounted generally adjacent to the pivot axis A and/or one or more of the pivot points 106, 108. For example, in one aspect, the angular rate sensor 110 may be positioned about 0 to about 30 centimeters from the pivot point 106. In another aspect, the angular rate sensor may be positioned about 5 to about 20 centimeters from the pivot point 106. In another aspect, the angular rate sensor 110 may be positioned as closely as possible to the pivot axis A and/or one or more of the pivot points 106, 108.

The angular rate sensor 110 may be any available sensor capable of measuring angular velocity or rotational speed.

At this point, those skilled in the art will appreciate that the disclosed system and method for measuring wheel velocity allows the user to measure relative wheel velocity directly (i.e., without integration or differentiation), thereby allowing the system to function at a higher frequency with a quicker and more robust response time. Furthermore, those skilled in the art will appreciate that the angular rate sensor 110 may be mounted at each corner of the vehicle according to the system and method disclosed herein without the need for customization or modification.

Accordingly, when a road condition applies a force to one or more wheels of the vehicle, the unsprung mass 104 may pivot relative to the sprung mass 102 about the pivot axis A at a measurable rotational speed. The measurable rotational speed may be directly monitored by the angular rate sensor 110 at each corner 100 of the vehicle and signals indicative of the measurable rotational speed may be communicated to a controller 112 by way of a wired or wireless communication line 114. In one aspect, the controller 112 may generate a command signal based upon the rotational speed signals, thereby controlling one or more active components (e.g., a damper, a motor, an actuator or the like).

Although various aspects of the disclosed system and method for measuring relative wheel velocity have been shown and described, modifications may occur to those skilled in the art upon reading the specification. The present application includes such modifications and is limited only by the scope of the claims.

What is claimed is:

1. A system for measuring relative wheel velocity comprising:
an unsprung mass having a wheel connected thereto;
a sprung mass pivotally connected to said unsprung mass by at least one pivot point; and
an angular rate sensor mounted on said sprung mass generally adjacent to at least one of said pivot points.

2. The system of claim 1 wherein said sprung mass is adapted to pivot relative to said unsprung mass at a measurable rotational speed.

3. The system of claim 2 wherein said angular rate sensor is adapted to measure said measurable rotational speed.

4. The system of claim 1 wherein said angular rate sensor is positioned about 0 to about 30 centimeters from at least one of said pivot points.

5. The system of claim 1 wherein said angular rate sensor is positioned about 5 to about 20 centimeters from at least one of said pivot points.

6. The system of claim 1 further comprising a controller in communication with said angular rate sensor.

7. The system of claim 6 wherein said angular rate sensor communicates with said controller by at least one of a wireless communication line and a wired communication line.

8. The system of claim 6 further comprising an active component in communication with said controller, wherein said active component is adapted to receive command signals from said controller.

9. A system for measuring relative wheel velocity comprising:
an unsprung mass having a wheel connected thereto;
a sprung mass pivotally connected to said unsprung mass by at least one pivot point; and
an angular rate sensor mounted on said unsprung mass generally adjacent to at least one of said pivot points.

10. The system of claim 9 wherein said sprung mass is adapted to pivot relative to said unsprung mass at a measurable rotational speed.

11. The system of claim 10 wherein said angular rate sensor is adapted to measure said measurable rotational speed.

12. The system of claim 9 wherein said angular rate sensor is positioned about 0 to about 30 centimeters from at least one of said pivot points.

13. The system of claim 9 wherein said angular rate sensor is positioned about 5 to about 20 centimeters from at least one of said pivot points.

14. The system of claim 9 further comprising a controller in communication with said angular rate sensor.

15. The system of claim 14 wherein said angular rate sensor communicates with said controller by at least one of a wireless communication line and a wired communication line.

16. The system of claim 14 further comprising an active component in communication with said controller, wherein said active component is adapted to receive command signals from said controller.

17. A method for measuring relative wheel velocity comprising the steps of:
providing a vehicle having a sprung mass pivotally connected to an unsprung mass by at least one pivot point;
mounting an angular rate sensor on at least one of said sprung mass and said unsprung mass such that said angular rate sensor is positioned generally adjacent to at least on of said pivot points; and
monitoring a signal generated by said angular rate sensor when said sprung mass pivots relative to said unsprung mass.

18. The method of claim 17 wherein said sprung mass pivots relative to said unsprung mass at a measurable rotational speed and said signal is indicative of said measurable rotational speed.

19. The method of claim 17 wherein said positioning step includes positioning said angular rate sensor about 0 to about 30 centimeters from at least one of said pivot points.

20. The method of claim 17 further comprising the step of communicating said signal to a controller.
